(19) United States
(12) Patent Application Publication
(10) Pub. No.: US 2014/0297393 A1
(43) Pub. Date: Oct. 2, 2014

(54) ACTIVITY BASED INCENTIVES

(71) Applicant: DOSEESAY LLC, Murray, UT (US)

(72) Inventor: Kelly D. Phillipps, Salt Lake City, UT (US)

(73) Assignee: DOSEESAY LLC, Murray, UT (US)

(21) Appl. No.: 14/231,525

(22) Filed: Mar. 31, 2014

Related U.S. Application Data
(60) Provisional application No. 61/806,761, filed on Mar. 29, 2013.

(51) Int. Cl. G06Q 30/02

(52) U.S. Cl. CPC G06Q 30/0239
USPC 705/14.39

(57) ABSTRACT

Apparatuses, systems, methods, and computer program products are disclosed for activity based incentives. A tracking module may be configured to monitor a user's participation in a physical activity. A data module may be configured to collect activity data in response to monitoring the user's participation in the physical activity. An incentive module may be configured to present one or more retail incentives to the user based on the activity data.

### CROSS-REFERENCES TO RELATED APPLICATIONS

This application claims the benefit of U.S. Provisional Patent Application No. 61/806,761 entitled “ACTIVITY BASED INCENTIVES” and filed on Mar. 29, 2013, for Kelly D. Phillipps, which is incorporated herein by reference.

### BACKGROUND

1. Field

This invention relates to retail incentives and more particularly relates to providing retail incentives based on a user's participation in a physical activity.

2. Description of the Related Art

Existing incentives-based systems focus on retaining customers by rewarding them for purchases or other contributions that are reactive in nature. The problem with a reactive-based system is that it does not directly promote new customer growth. Reward systems based on purchases, with the hopes of driving future sales, is a good way to retain customers, but offers little assistance in acquiring new customers. Existing rewards systems that are designed at acquiring new customers may come in the form of discount coupons and offers; yet, these systems provide little guidance about a customer's customer's purchasing and consumption behaviors because the customer has yet to make a purchase.

### BRIEF SUMMARY

Apparatuses are presented for activity based incentives. In one embodiment, a tracking module is configured to monitor a user's participation in a physical activity. A data module, in some embodiments, is configured to collect activity data in response to monitoring the user's participation in the physical activity. In certain embodiments, an incentive module is configured to present one or more retail incentives to the user based on the activity data.

Methods are presented for activity based incentives. In one embodiment, a method includes tracking a user's participation in a physical activity. The method, in certain embodiments, includes collecting activity data in response to tracking the user's participation in the physical activity. In some embodiments, the method includes matching one or more sponsors associated with the physical activity to the user based on information associated with the activity data. In one embodiment, the one or more sponsors provide one or more retail incentives to the user.

Computer program products are presented comprising a computer readable storage medium storing computer usable program code executable to perform operations for activity based incentives. In one embodiment, an operation includes tracking a user's participation in a physical activity. In some embodiments, an operation includes collecting activity data in response to tracking the user's participation in the physical activity. An operation, in certain embodiments, includes presenting one or more retail incentives to the user based on the activity data. In some embodiments, the one or more retail incentives may be offered by one or more sponsors associated with the physical activity.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for activity based incentives in accordance with the present invention;

FIG. 2 is a schematic block diagram illustrating one embodiment of a module for activity based incentives in accordance with the present invention;

FIG. 3 is a schematic block diagram illustrating one embodiment of another module for activity based incentives in accordance with the present invention;

FIG. 4 is an illustration of one embodiment of a graphical output in accordance with the present invention;

FIG. 5 is a schematic flow chart diagram illustrating one embodiment of a method for activity based incentives in accordance with the present invention; and

FIG. 6 is a schematic flow chart diagram illustrating one embodiment of another method for activity based incentives in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

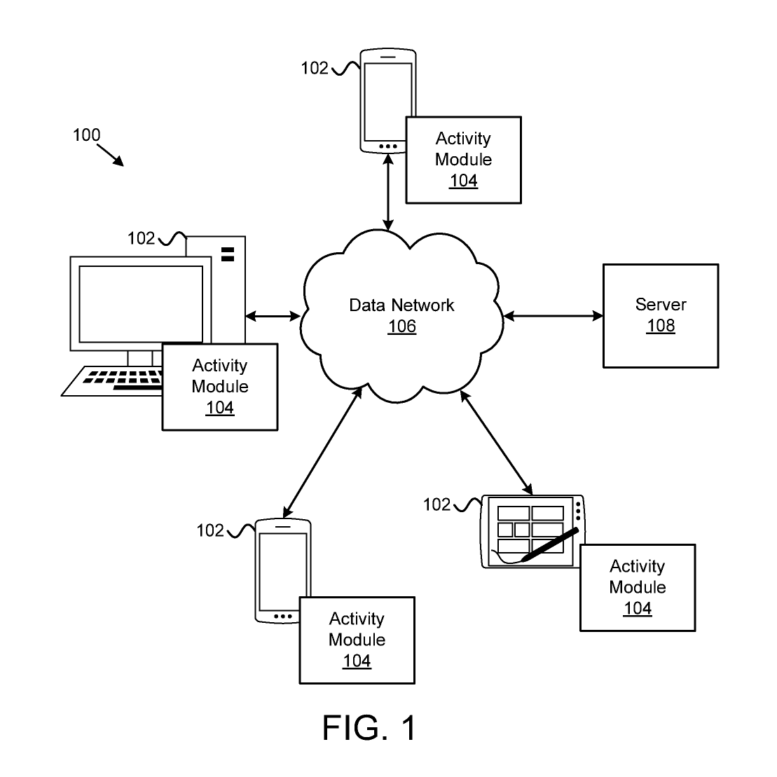

FIG. 1 depicts one embodiment of a system 100 for activity based incentives. In one embodiment, the system 100 includes a plurality of information handling devices 102, a plurality of activity modules 104, a network 106, and a server 108, which are described in more detail below. Even though a specific number of information handling devices 102, activity modules 104, networks 106, and servers 108 are depicted in FIG. 1, any number of information handling devices 102, activity modules 104, networks 106, and servers 108 may be included in the system 100.

In one embodiment, the information handling devices 102 include electronic devices comprising a processor and memory, such as a desktop computer, a laptop computer, a smart phone, a tablet computer, a smart TV, an eBook reader, a smart watch, an optical head-mounted display, and/or the like. In some embodiments, the information handling devices 102 include wearable activity-tracking devices 102 that are configured to monitor a user's activity, such as fitness bands, smart watches, or the like. The information handling devices 102 may monitor activity data such as a number of steps walked/run, calorie consumption, heart rate, blood pressure, quality of sleep, or the like. The information handling devices 102, in some embodiments, include one or more sensors that track data associated with a user's activity, such as location sensors, proximity sensors, biometric sensors, accelerometers, gyroscopes, cameras, and/or the like.

The information handling devices 102 may store activity data on the device 102 or may send data to the server 108 through the data network 106 to be stored remotely. In some embodiments, an information handling device 102 communicates with another information handling device 102, such as a smart phone, through the data network 106 to send and/or receive activity data to/from the smart phone. The information handling device 102, in some embodiments, includes wireless communication functionality such as Wi-Fi, Bluetooth®, near-field communication (NFC), or the like.

The server 108, in some embodiments, includes a main frame computer, a desktop computer, a laptop computer, a cloud server, a virtual server or the like. In certain embodiments, the server 108 includes at least a portion of the activity module 104. In one embodiment, the information handling device 102 is communicatively coupled to the server 108 through the data network 106. In certain embodiments, the information handling device 102 offloads at least a portion of the information processing associated with the activity module 104, such as data processing, graphic visualization processing, or the like, to the server 108. The server 108 may include one or more computer readable storage devices configured to store activity data generated by an activity tracking device 102, which may be accessible by the information handling devices 102 via the data network 106.

The data network 106, in one embodiment, is a digital communication network 106 that transmits digital communications related to an activity based incentive system 100. The digital communication network 106 may include a wireless network, such as a wireless cellular network, a local wireless network, such as a Wi-Fi network, a Bluetooth® network, and the like. The digital communication network 106 may include a wide area network (WAN), a storage area network (SAN), a local area network (LAN), an optical fiber network, the internet, or other digital communication network. The digital communication network 106 may include two or more networks. The digital communication network 106 may include one or more servers, routers, switches, and/or other networking equipment. The digital communication network 106 may also include computer readable storage media, such as a hard disk drive, an optical drive, non-volatile memory, random access memory (RAM), or the like.

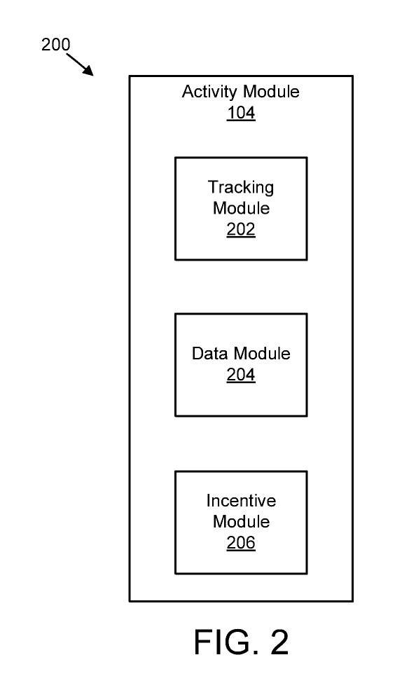

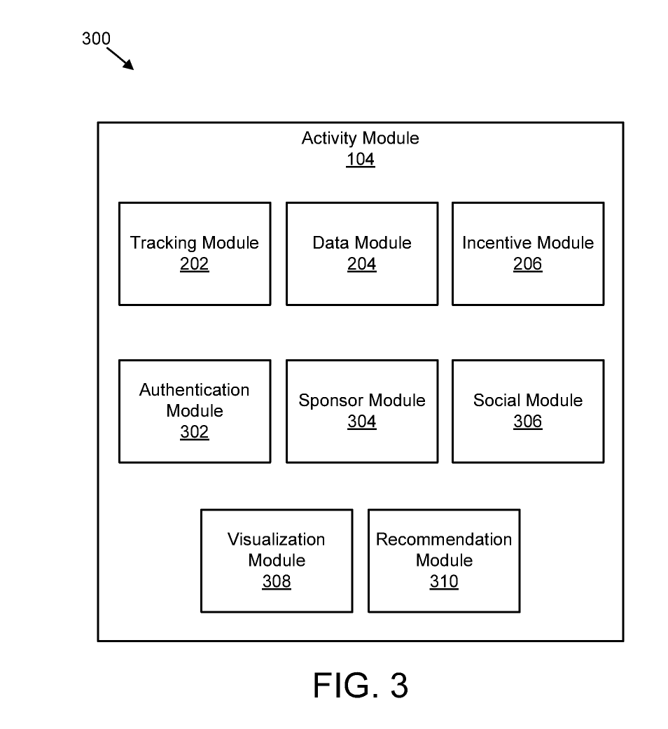

The activity modules 104, in one embodiment, are configured to monitor a user's participation in an activity using an information handling device 102. In some embodiments, the activity modules 104 are configured to collect activity data in response to monitoring the user's participation in the activity. Additionally, the activity modules 104 may be configured to present one or more retail incentives to the user based on the activity data generated by the user's participation in the activity. In certain embodiments, the activity modules 104 include a plurality of modules to perform the operations of the activity modules 104. The activity module 104, and its associated modules, are described in more detail below with reference to FIGS. 2 and 3.

FIG. 2 depicts one embodiment of a module 200 for activity based incentives. In one embodiment, the module 200 includes an embodiment of an activity module 104. The activity module 104, in certain embodiments, includes a tracking module 202, a data module 204, and an incentive module 206, which are described in more detail below.

The tracking module 202, in one embodiment, is configured to monitor a user's participation in a physical activity. In some embodiments, the physical activity includes activities that involve the user's movement, such as skiing, mountain biking, running, hiking, rock climbing, basketball, or the like. The tracking module 202, in certain embodiments, uses one or more sensors of an information handling device 102 to monitor the user's activity. For example, the tracking module 202 may monitor a mountain biker's location using a global positioning system (GPS) of a smart phone 102. The tracking module 202 may monitor other personal metrics of the user, such as the user's heart rate using a biometric sensor of a fitness band, the intensity of the mountain bike trail using an accelerometer and/or gyroscope of a smart phone, or the like. In some embodiments, the tracking module 202 is enabled in response to an application on an information handling device 102 being executed during the activity.

The data module 204, in one embodiment, is configured to collect activity data in response to monitoring the user's participation in the physical activity. In certain embodiments, the data module 204 receives activity data generated by the tracking module 202. The data module 204, in some embodiments, collects various data points in the activity data. For example, the activity data may include location data, such as GPS coordinates, a latitude and longitude, a path taken during an activity, or the like; biometric data, such as the user's heart rate, blood pressure, or the like; the type of activity, such as skiing, mountain biking, or the like; the time of the activity; weather information, such as temperature, precipitation, humidity, wind speed and direction, or the like; elevation data; social data, such as user comments, posts, or the like from one or more social media locations; and multimedia data, such as audio, video, photographs, or the like. The data module 204, in certain embodiments, may associate various activity data with location data (e.g., a point along a path taken during the activity), with a timestamp, or the like.

Additionally, the data module 204 may include data describing one or more characteristics of the activity in the activity data. Activity characteristics, as used herein, describe various features of the activity, such as the type of activity, the intensity of the activity, the difficulty of the activity, the duration of the activity, the distance of the activity, or the like. For example, for a skiing activity, the data module 204 may include characteristics for the ski run, such as the difficulty of the ski run (e.g., black diamond, or the like), the intensity of the ski run, the length of the ski run, the duration of the ski run, or the like.

In certain embodiments, the data module 204 stores collected activity data locally on the information handling device 102. Alternatively, the data module 204 sends activity data to a remote server 108 to be stored. In such an embodiment, the data module 204, and other modules, access the activity data through the data network 106. For example, the server 108 may comprise a cloud server 108 and may be accessible to any information handling device 102 capable of communicating with the server 108 through the data network 106. The data module 204 may sync locally collected activity data from an information handling device 102 to the cloud server 108 while the user participates in the activity or sometime thereafter. In some embodiments, the data module 204 syncs activity data to the server 108 at predetermined intervals or according to a predetermined schedule.

The incentive module 206, in one embodiment, is configured to present one or more retail incentives to the user based on the user's activity data. As used herein, retail incentives may include coupons, offers, promotions, rewards, points, credits, badges, achievements, or the like that are related to the activity that the user participated in. For example, the incentive module 206 may present incentives for products related to mountain biking in response to the user participating in a mountain biking activity, such as helmets, tires, frames, handlebars, or the like. In one embodiment, the incentive module 206 may present incentives for services related to the activity. For example, the incentive module 206 may present incentives for mountain bike repair shops if the user participated in a mountain biking activity.

In one embodiment, the incentive module 206 presents incentives based on characteristics of the activity, such as the intensity or difficulty of the activity. For example, in response to a user participating in a dirt bike ride, the incentive module 206 may present incentives for dirt bike tires, shocks, handlebars, seats, or the like. In certain embodiments, the incentive module 206 may present incentives for different types of events within the same general activity. For example, the incentive module 206 may present mogul ski equipment if the user participated in a mogul skiing event instead of incentives related to downhill skiing, slalom skiing, or the like. In one embodiment, the value of the incentives is based on the intensity, difficulty, duration, or the like, of the activity. For example, the incentive module 206 may present a $20.00 coupon to a user who runs a marathon and a $10.00 coupon to a user who runs a half marathon. Additionally, the incentive module 206 may present incentives associated with restaurants, hotels, travel, or the like, based on characteristics of the activity, such as the location of the activity, time of the activity, duration of the activity, or the like.

In certain embodiments, the incentive module 206 presents incentives provided by one or more sponsors associated with the activity, the user, or the like. For example, a running equipment company may sponsor a marathon that the user in participating in. In some embodiments, the incentive module 206 presents incentives to a user on an information handling device 102, such as by sending the user a text message, email message, chat message, or the like. In one embodiment, the incentive module 206 presents incentives to the user through an application executing on the user's information handling device 102. In certain embodiments, the incentive module 206 sends the user a link to a sponsor's website, ecommerce site, online store, or the like such that the user may redeem incentives that they received, such as coupons, loyalty points, rewards, gift cards, or the like.

FIG. 3 depicts one embodiment of another module 300 for activity based incentives. In one embodiment, the module 300 includes an embodiment of an activity module 104. In certain embodiments, the activity module 104 includes a tracking module 202, a data module 204, and an incentive module 206, which may be substantially similar to the tracking module 202, the data module 204, and the incentive module 206 described above with reference to FIG. 2. The activity module 104, in some embodiments, includes an authentication module 302, a sponsor module 304, a social module 306, a visualization module 308, and a recommendation module 310, which are described in more detail below.

In one embodiment, the authentication module 302 is configured to encrypt the activity data collected by the data module 204 to ensure the integrity of the activity data. The authentication module 302, in certain embodiments, encrypts data stored on the information handling device 102. In one embodiment, the authentication module 302 encrypts data stored on the server 108. In certain embodiments, the authentication module 302 stores the activity data collected for all participants of an activity in a central server 108 and encrypts the activity data using a unique identifier associated with the central server 108. The authentication module 302 may also encrypt data that is sent over the data network 106. In some embodiments, the authentication module 302 associates stored activity data with a private key instead of a user identifier, which may maintain the anonymity of the user associated with the data.

The authentication module 302, in some embodiments, is part of an application executing on an information handling device 102 that determines how and/or when to encrypt/decrypt data stored on the information handling device 102. In some embodiments, the activity data is stored in a data repository associated with the physical activity. For example, the data module 204 may store activity data for a mountain biking activity in a different data store than activity data associated with a skiing activity.

In certain embodiments, the authentication module 302 is configured to validate the user's participation in the physical activity by verifying the activity data. In one embodiment, the authentication module 302, in order to verify the activity data, assigns a unique identifier to the activity data. In some embodiments, the unique identifier is associated with the user, the physical activity, and/or a device 102 monitoring the user's participation in the activity. In this manner, the authentication module 302 associates the activity data with a single user or with an information handling device 102 that is used to track the user's participation in the activity. In some embodiments, the authentication module 302 registers a user's information handling device 102 that is being used to track the user's participation in the activity such that the user may only be associated with activity data collected on the registered device 102. In certain embodiments, the authentication module 302 encrypts the activity data using a unique identifier associated with the registered information handling device 102, the user, and/or the activity.

In one embodiment, the authentication module 302 is further configured to compare the activity data for the user with activity data associated with one or more different users to validate the user's participation in the physical activity. For example, the authentication module 302 may verify the user was participating in a cycling activity and not an ATV activity by comparing the user's activity data to one or more different users' cycling activity data. In such an embodiment, the authentication module 302 may determine whether one or more characteristics of the activity data match, or are within a predetermined threshold of, the other user's activity data. For example, the authentication module 302 may compare elevation data, speed data, weather data, or the like, at a particular GPS location.

The authentication module 302 may compare the activity data for the user with activity data associated with one or more different users to verify the user's activity data is not identical, or within a predetermined threshold of, the other user's data. In some embodiments, the authentication module 302 compares a subset of the activity data with a similar subset of another user's activity data. The activity data subsets may include distinct points of interest for the activity, such as a large jump in a motocross event, a steep hill in a mountain biking event, or the like. In this manner, the authentication module 302 may determine whether the user's data is fraudulent (e.g., is an identical, unauthorized copy of a different activity data set), which may indicate the user did not actually participate in the activity.

In one embodiment, the sponsor module 304 is configured to match one or more sponsors to the user. A sponsor, as used herein, may comprise an individual, business, corporation, non-profit organization, or the like, that may provide one or more retail incentives to a user for the user's participation in a physical activity. Sponsors may be specific to a particular activity, and may also be associated with one or more activities. For example, a bike retailer may sponsor a mountain biking activity and/or a cycling activity. The goal of a sponsor may be to generate new customer interest, advertising, or the like, for a particular product or service that is associated with an activity or a user.

In one embodiment, the sponsor module 304 is configured to present activity data for a plurality of users to a plurality of sponsors and to receive sponsorship bids from the plurality of sponsors. The sponsor module 304 may present the activity data on a website, application, or the like, which sponsors, or potential sponsors, may access to determine which user's to bid on for sponsorships. For example, a mountain bike retailer may want to sponsor a mountain biker. The retailer may check a website, provided by the sponsor module 304, that is associated with a recent mountain biking competition and lists the competitors' activity data, as tracked and collected by the tracking module 202 and the data module 204. Based on the activity data, the retailer may determine which mountain bikers to bid on to become one of the mountain bikers' sponsors. The retailer may also target products and services to particular users based on the user's activity data.

In one embodiment, the sponsor module 304 presents a list of sponsors to a user participating in an activity. The sponsor module 304 may receive solicitations from users for one or more of the listed sponsors. For example, a marathon runner may solicit a shoe company to be his sponsor for an upcoming marathon. The sponsor module 304, in certain embodiments, receives a user's declared allegiance to a specific brand, company, service, product, or the like, associated with sponsors in order to solicit retailers to become sponsors of the user. The sponsor module 304 may present the declared allegiances to sponsors, who may filter the listed users by their declared allegiances.

The sponsor module 304 may receive incentive information from the sponsors, which may include the types of incentives, the value of the incentives, sponsors' names, links to sponsors' website and ecommerce store, and/or the like. For example, the sponsor module 304 may receive a bid from a ski equipment retailer for a particular skier participating in a ski event. The bid may include the sponsor's information and one or more incentives that the sponsor is offering to the skier. The sponsor module 304 may receive the skier's decision regarding the bid, which may include accepting the sponsor's offer, presenting a counteroffer, or declining the sponsor's bid.

The sponsor module 304 may present incentives that increase in value as a user becomes more popular, participates in more activities, wins more competitions, or the like. For example, the sponsor module 304 may present a tiered coupon, the value of which is based on how the user finishes in a competition. The coupon may be for 10% off at the sponsor's store for finishing in the top 10, 20% off for finishing in the top 5, and 30% off for finishing in first place, in one embodiment. In some embodiments, the value of the incentives is based on one or more characteristics of the activity, such as the difficulty, intensity, duration, or the like, of the activity. For example, the sponsor module 304 may present more valuable incentives to a mountain biker that participates in a longer mountain bike ride than a different biker that participates in a shorter ride.

In certain embodiments, the sponsor module 304 presents targeted incentives to a user based on the user's activity data. In some embodiments, the sponsor module 304 determines similarities between users' activity data for a particular activity, such as speed, heart rate, or the like, and similarities between the users' product purchase information to determine which incentives to present to the user (e.g., which products and services to target to the user). The sponsor module 304 may track purchases from sponsors made by other users with similar activity data characteristics as the user to determine targeted incentives for products and services that the user would likely be interested in purchasing. For example, if a majority of participants for a particular motocross event purchase, or use, a particular handlebar prior to the event, an offer for the purchase of the handlebar, such as a coupon or discount, may be presented to the user before the user participates in the motocross event.

In one embodiment, the sponsor module 304 may determine the value of a user based on the user's activity data. The sponsor module 304 may determine a user's value based on a predetermined formula, which may take into account such things as the user's popularity, success rate in competitions, the number of times the user participates in an activity, or the like. The sponsor module 304 may express the value of the user in terms of incentives, such as coupons, offers, points, rewards, or the like. The sponsor module 304, in one embodiment, tracks the determined user's value and may present it to the user or to the user's connections on the user's social media network.

In some embodiments, the sponsor module 304 tracks the status of the user's incentives and provides a summary of the user's value, which may include the incentives' value, the incentives' expiration date, or the like. The sponsor module 304, in one embodiment, presents the value of particular activities to the user such that the user may determine which activities to participate in based on the potential activity value. For example, cycling activity A may potentially be worth $100 in incentives, based on the characteristics of the activity, and cycling activity B may be worth $150, but it may be a more difficult and demanding activity than cycling activity A.

In one embodiment, the social module 306 is configured to post information associated with the user's participation in the physical activity on a social media network associated with the user. For example, the social module 306 may post the user's finishing position in a competition, the user's average speed, weather data for the event, the user's biometric information, or the like. In certain embodiments, the social module 306 posts multimedia data from the user's participation in the event, such as photos, videos, or the like, on the user's social media networks. In one embodiment, the social module 306 posts a summary of the activity on the user's social media networks, which may include general information about the activity such as the location of the event, the top and average speeds, the date of the event, or the like. The social module 306 may also post event specific data, such as the length of a ski run, the difficulty of a mountain bike trail, the marathon runner's average pace, or the like.

In one embodiment, the social module 306 posts sponsor information associated with the user, such as links to the sponsor's website or ecommerce store. The social module 306, in certain embodiments, posts information about sponsors' products, services, or the like that the user has purchased, uses, or endorses. For example, the social module 306 may post an image of a set of skis provided by a sponsor that a skier used for a particular event, with a link to the sponsor's website/ecommerce store and one or more coupons for the skis.

In some embodiments, the social module 306 is configured to receive a fraud report from one or more users of the social media network. In some embodiments, the fraud report describes fraudulent information associated with the physical activity posted by the user. For example, a user may post fraudulent information regarding their “participation” in an event in the hopes of receiving product incentives from sponsors. The user's social network community may determine that the posted information is fraudulent based on first-hand experience, knowledge, or the like and may report the fraudulent information. In one embodiment, the social module 306 monitors potentially fraudulent information in response to the social media community flagging the posted information as being suspect.

In one embodiment, the social module 306 receives feedback associated with the user's participation in the activity from one or more social media users. The social module 306, for example, may receive rankings, comments, ratings, or the like, associated with the posted information related to the user's participation in the activity. In some embodiments, the sponsor module 304 incorporates social media data into a user's profile that is presented to sponsors to help sponsors determine who to bid on for sponsorships. For example, a user that has thousands of followers on Twitter® may be more desirable to a sponsor than a user that only has a few hundred. Similarly, a sponsor may want to bid on a user that receives a lot of comments on his Facebook® page.

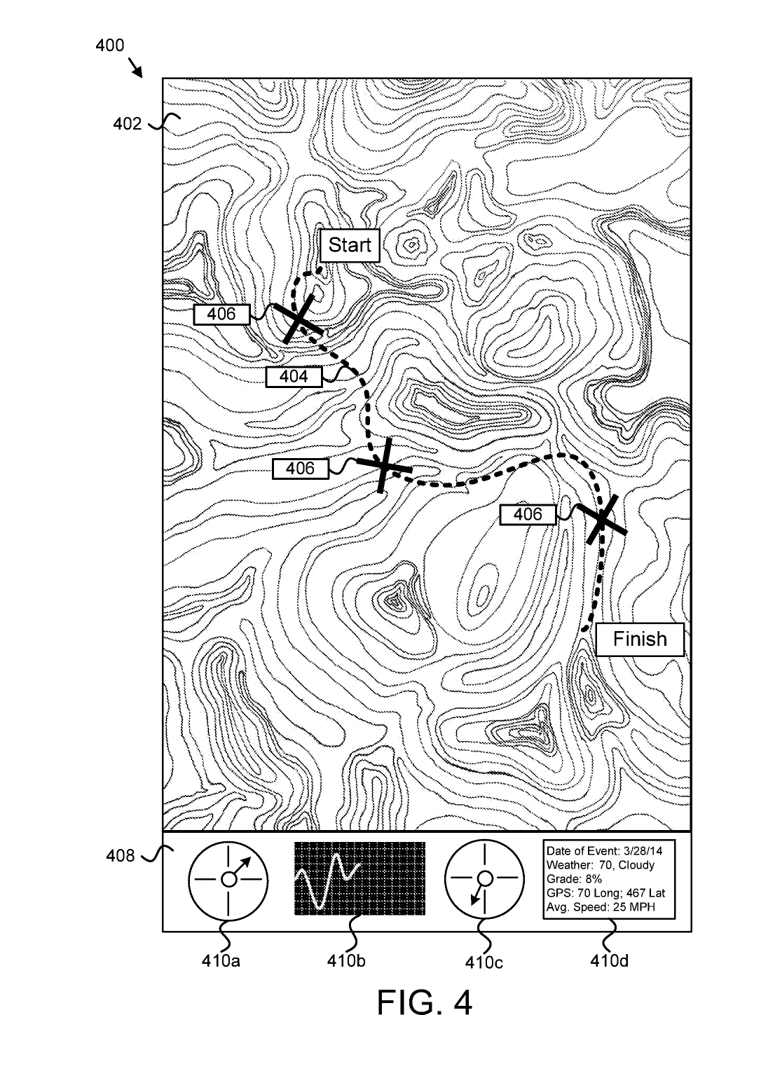

The visualization module 308, in one embodiment is configured to generate a graphical representation of the physical activity based on the activity data. In some embodiments, the visualization module 308 presents the graphical representation of the physical activity within an interactive virtual environment. The visualization module 308, in some embodiments, presents the interactive virtual environment on a two-dimensional (2D) or three-dimensional (3D) map representing the location and/or route of the activity, as depicted in FIG. 4. In certain embodiments, a route of an activity is depicted as a line that varies in length, thickness, color, or the like to indicate different intensities, difficulties, or other characteristics of the activity. The visualization module 308 may present the interactive virtual environment, including the map layer, on a display of an information handling device 102 such that a user may interact with the graphical representation of the activity and customized the presented data, including adding/removing other participants' data, comparing participants, filtering data elements to be displayed, and/or the like.

The interactive virtual environment generated by the visualization module 308 may include graphical representations of one or more predetermined data elements. For example, the visualization module 308 may include a speedometer, a compass, an artificial horizon, a clock, a stopwatch, an odometer, an altimeter, a heart rate monitor, and/or the like, which graphically represent respective data elements. The visualization module 308, in some embodiments, presents multimedia data, such as photos, videos, audio tracks, or the like, in the interactive virtual environment. The visualization module 308, in certain embodiments, presents social media data in the interactive virtual environment, such as comments, rankings, or the like. In some embodiments, the visualization module 308 presents weather data, elevation data, or the like at specific times and locations along the user's route. The visualization module 308 may filter presented data by relevance, popularity, proximity, date, and/or the like, as determined by a user.

In certain embodiments, the interactive virtual environment comprises an interface for replaying the user's participation in the physical activity based on the activity data. The visualization module 308 may comprise a rendering engine that generates a replay of the user's participation in the activity. For example, the visualization module 308 may graphically represent a replay of a user's mountain bike ride from start to finish. As the biker's route is replayed, one or more of the graphical representations of the data are updated. Thus, the visualization module 308 updates the speedometer, the heart rate monitor, or the like as the biker's activity is replayed. The visualization module 308 may adjusts various aspects of the replay in response to user input, such as speeding up or slowing down the replay, pausing the replay, zooming in on a particular area of the replay, selecting different viewpoints, and/or the like. In some embodiments, the visualization module 308 simulates an activity and predicts the user's performance in the simulated activity based on the user's activity data.

In certain embodiments, the visualization module 308 is configured to present graphical representations of activity data for a plurality of users simultaneously within the interactive virtual environment. The visualization module 308 may replay the activity data of the plurality of users at the same time within the interactive virtual environment. In certain embodiments, the visualization module 308 overlays each graphical representation of the activity data for the plurality of users and uses different colors, line designs, line shapes, and/or the like to represent each user. For example, the visualization module 308 may present a graphical representation of each run for each skier in a ski competition so that a viewer may replay and compare each skier's run at the same time.

In some embodiments, the visualization module 308 presents comparison information within the interactive virtual environment associated with the activity data for the plurality of users. In certain embodiments, the visualization module 308 selects which users' data is presented within the interactive virtual environment in response to user input. For example, a viewer may filter activity data for one or more friends, heroes, users within a certain age group, users with the fastest times or slowest times, the best or worst performers, or the like. Alternatively, the visualization module 308 may filter activity data based on different events, event dates (e.g., most recent or oldest activities), or the like. In some embodiments, a sponsor may select user from the interactive virtual environment to see the user's profile, offer incentives, and/or the like. In some embodiments, the visualization module 308 normalizes the activity data of each user presented in the interactive virtual environment by time, speed, or the like, in order to provide relative comparisons. For example, the visualization module 308 may normalize the activity data of a very fast skier and a very slow skier in order to compare differences between the two different activity data sets besides speed.

In one embodiment, the recommendation module 310 is configured to extrapolate the activity data to generate one or more recommendations for the physical activity. For example, based on activity data for a plurality of mountain bikers, the recommendation module 310 may generate one or more recommendations for the mountain bike route, optimal speeds through various sections of the route, and/or the like. Based on the recommendations, the sponsor module 304 may present one or more retail incentives based on the recommendations. For example, the sponsor module 304 may present incentives for skiing equipment that may help a skier perform better at a particular skiing activity. The recommendation module 310 may also use a user's purchase history to determine product or service recommendations. In some embodiments, the recommendation module 310 determines an optimal incentive value to be offered for activities, users, and/or the like, based on activity data for a plurality of users. In some embodiments, the recommendation module 310 recommends potential matches between sponsors and users based on the user's activity data and the sponsors' preferences.

In one embodiment, the recommendation module 310 is configured to generate recommendations based on similarities between a plurality of users. In one embodiment, the recommendation module 310 searches for new activities for a user based on overlapping factors between the user's activity data and other participants' activity data. For example, if user A and user B ski substantially similar ski runs, in terms of difficulty, duration, distance, or the like, the recommendation module 310 may recommend any other ski runs favored by either user to the other user (e.g., user A runs are recommended to user B and vice versa). In certain embodiments, the recommendation module 310 groups different users into recommended teams for team-related events, such as relay races, or the like, based on the users' activity data.

FIG. 4 depicts one embodiment of a graphical output 400 for an interactive graphical environment. In one embodiment, the visualization module 308 presents the interactive graphical environment on an information handling device 102. In some embodiments, the interactive graphical environment may include a map 402, which may be a 2D or 3D map, a topographical map, and/or the like that displays the location of the activity. The visualization module 308 may depict the user's participation in the activity using a line 404 that illustrates the route of the user, such as a mountain biking trail, a ski run, or the like. The line may vary in size, thickness, design, based on the characteristics of the activity and the user's activity data. For example, the visualization module 308 may color the line red at difficult points of the activity or may make the line thicker to show portions of the activity where the user was going slow and thinner to show portions of the activity where the user was going fast.

In some embodiments, the visualization module 308 presents one or more points of interest 406 along the user's route. The visualization module 308 may display information associated with the points of interest 406 in response to a viewer interacting with a point of interest 406. For example, a point of interest 406 may depict the location where a user crashed, where a user passed another user in a race, or the like. A viewer may select a point of interest 406 to display the data for that location, which may include activity information, weather data, elevation data, speed data, and/or the like. The visualization module 308, at any point along the path 404, may display weather data, activity data (e.g., speed, heart rate, position, or the like), elevation data, or the like, in response to user input. In one embodiment, the visualization module 308 may present social media data, such as comments, or the like, at particular points along the path 404 in response to the interactive graphical environment being posted to the user's social media network.

In certain embodiments, the visualization module 308 presents multiple lines 404, with each line representing a participant of the activity. The lines 404 may each have their own design, color, thickness, or the like such that each participant's route is visually distinguishable. The visualization module 308 may replay each participant's activity data independently or simultaneously such that an actual race may be replayed or a virtual race may be viewed if the event was an individual event. For example, many downhill skiing events are individual events. After each skier has finished the event, the visualization module 308 may depict each skier's activity data on a map of the ski route and replay each skier's performance to generate a virtual race. In some embodiments, the recommendation module 310 may also present a graphical representation of a recommended path based on the participants' activity data.

In one embodiment, the visualization module 308 presents a control panel 408 that includes a plurality of graphical representations 410a-d of predetermined data elements of the activity data. For example, the control panel 408 may include a speedometer 410a, a heart rate monitor 410b, an elevation gauge 410c, and a general information display 410d, which displays activity data for a particular location and time along the path, such as weather data, GPS coordinates, the grade/incline of the path, the average speed, and/or the like. The visualization module 308, in one embodiment, updates the control panel 408 elements 410a-d as the user's activity data is replayed in the interactive graphical environment.

In certain embodiments, the sponsor module 304 presents one or more incentives to users, friends of the users, or the like within the interactive graphical environment. The sponsor module 304 may include a link to the sponsor's website/ecommerce store, which a viewer may use to view the sponsor's products and services and to redeem an offered incentive. The sponsor module 304, in some embodiments, receives sponsor bids and incentive offers from sponsors in response to the sponsors replaying a user's participation in the activity.

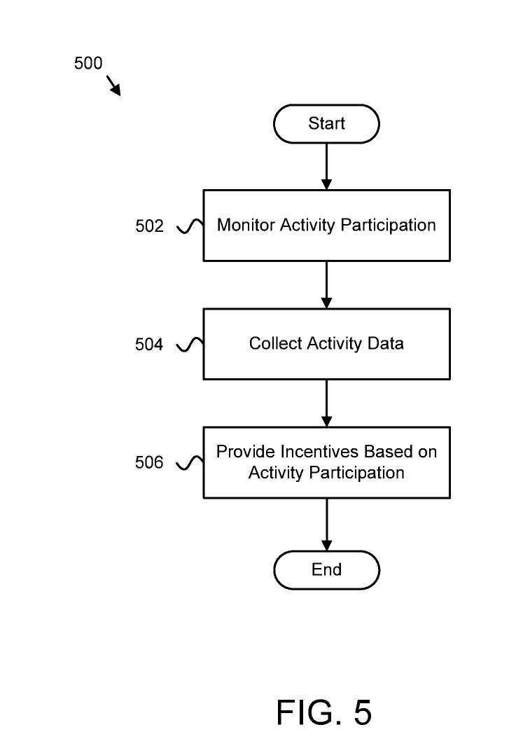

FIG. 5 depicts a schematic flow chart diagram illustrating one embodiment of a method 500 for activity based incentives. In one embodiment, the method 500 begins and the tracking module 202 monitors 502 a user's participation in a physical activity. In certain embodiments, the data module 204 collects 504 activity data in response to monitoring the user's participation in the physical activity. An incentive module 206, in some embodiments, presents 506 one or more retail incentives to the user based on the activity data, and the method 500 ends.

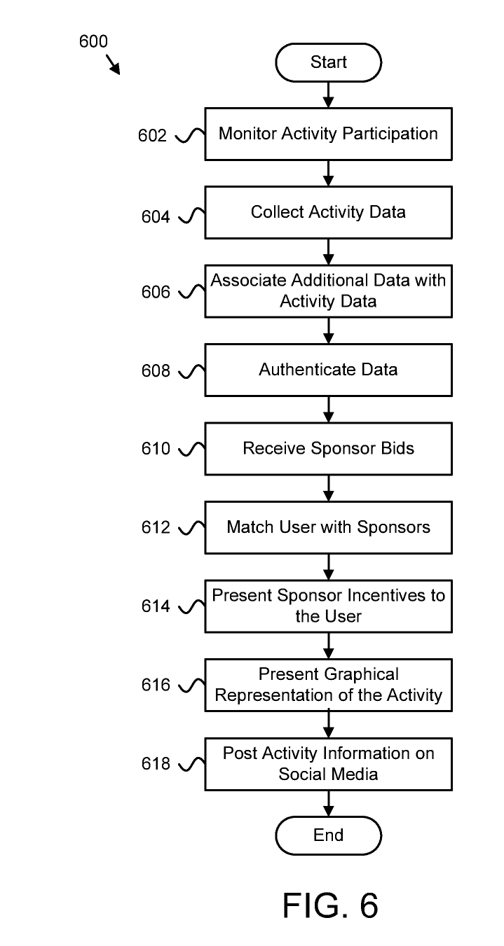

FIG. 6 depicts a schematic flow chart diagram illustrating one embodiment of another method 600 for activity based incentives. In one embodiment, the method 600 begins and the tracking module 202 monitors 602 a user's participation in a physical activity. The tracking module 202 may use one or more sensors of an information handling device 102, such as GPS, radio-frequency identification (RFID), or the like, to track 602 the user as the user participates in a physical activity. The tracking module 202 may track 602 various aspects of a user, such as the user's location, biometric information, weather information, or the like.

In one embodiment, a data module 204 collects 604 activity data in response to monitoring the user's participation in the physical activity. The data module 204 may collect 604 activity-specific data, such as the user's location, the user's speed, the user's elevation, the activity duration, the activity intensity, or the like. In some embodiments, the data module 204 associates 606 additional data with the activity data, such as weather data, social media data, biometric data, multimedia data, or the like.

In one embodiment, the authentication module 302 authenticates 608 the activity data associated with the user in order to verify the user participated in the activity. In some embodiments, the authentication module 302 encrypts the activity data collected by the data module 204 to ensure the integrity of the activity data. The authentication module 302, in certain embodiments, authenticates 608 the activity data by verifying a unique identifier assigned to the activity data. In one embodiment, the authentication module 302 authenticates 608 the activity data by comparing the activity data for the user with activity data associated with one or more different users to validate the user's participation in the physical activity. In such an embodiment, the authentication module 302 may determine whether one or more characteristics of the activity data match, or are within a predetermined threshold of, the other user's activity data.

In a further embodiment, the sponsor module 304 receives 610 bids from sponsors for one or more participants in an activity. In certain embodiments, the sponsor module 304 presents users' activity data to the sponsors such that the sponsors can determine which users to bid on. In one embodiment, the sponsor module 304 matches 612 a user with a sponsor based on the sponsors bids. In certain embodiments, the sponsor module 304 matches 612 a user with a sponsor based on predetermined criteria, such as the user's performance in an activity matching the sponsor's preferences, or the like.

In some embodiments, the incentive module 206 presents 614 one or more retail incentives to the user based on the user's activity data. The incentives may include coupons, offers, promotions, rewards, points, credits, badges, achievements, or the like that are related to products and services associated with the activity. In one embodiment, the incentive module 206 presents 614 incentives that have a value based on characteristics of the activity, such as the intensity or difficulty of the activity. In certain embodiments, the incentive module 206 presents 614 incentives provided by one or more sponsors associated with the activity, the user, or the like.

In one embodiment, the visualization module 308 presents 616 a graphical representation of the physical activity based on the activity data. In some embodiments, the visualization module 308 presents 616 the graphical representation of the physical activity within an interactive virtual environment. In certain embodiments, the interactive virtual environment comprises an interface for replaying the user's participation in the physical activity based on the activity data. For example, the visualization module 308 may graphically represent a replay of a user's mountain bike ride from start to finish based on the activity data collected by the data module 204.

In a further embodiment, the social module 306 posts 618 activity data information associated with the user's participation in the physical activity on a social media network associated with the user. For example, the social module 306 may post 618 the user's finishing position in a competition, the user's average speed, weather data for the event, the user's biometric information, or the like. In certain embodiments, the social module 306 posts 618 the replay of the user's activity as generated by the visualization module 308. In one embodiment, the social module 306 posts 618 sponsor information associated with the user, such as links to the sponsor's website or ecommerce store. In some embodiments, the social module 306 is configured to receive a fraud report from one or more users of the social media network and may alert the authentication module 302 that a user's activity data is fraudulent. In one embodiment, the social module 306 receives feedback associated with the user's participation in the activity from one or more social media users, and the method 600 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a tracking module configured to monitor a user's participation in a physical activity;
a data module configured to collect activity data in response to monitoring the user's participation in the physical activity; and
an incentive module configured to present one or more retail incentives to the user based on the activity data.

2. The apparatus of claim 1, further comprising an authentication module configured to validate the user's participation in the physical activity by verifying the activity data, the activity data being stored in a data repository associated with the physical activity.

3. The apparatus of claim 2, wherein the authentication module is further configured to assign a unique identifier to the activity data, the unique identifier being associated with one or more of the user, the physical activity, and a device monitoring the user's participation.

4. The apparatus of claim 2, wherein the authentication module is further configured to compare the activity data for the user with activity data associated with one or more different users to validate the user's participation in the physical activity.

5. The apparatus of claim 1, further comprising a sponsor module configured to match one or more sponsors to the user, the one or more sponsors providing the one or more retail incentives presented to the user.

6. The apparatus of claim 5, wherein the one or more retail incentives provided by the one or more sponsors are based on one or more characteristics of the physical activity, the one or more characteristics determining a value of the one or more retail incentives.

7. The apparatus of claim 5, wherein the sponsor module is further configured to present activity data for a plurality of users to a plurality of sponsors, to receive bids from the plurality of sponsors, and to match the one or more sponsors to the user based on bids from the one or more sponsors.

8. The apparatus of claim 1, further comprising a social module configured to post information associated with the user's participation in the physical activity on a social media network associated with the user.

9. The apparatus of claim 8, wherein the social module is further configured to receive a fraud report from one or more users of the social media network, the fraud report describing fraudulent information associated with the physical activity posted by the user.

10. The apparatus of claim 1, wherein the activity data comprises one or more of location data, elevation data, weather data, biometric data, social data, and multimedia data.

11. The apparatus of claim 1, further comprising a visualization module configured to generate a graphical representation of the physical activity based on the activity data.

12. The apparatus of claim 11, wherein the visualization module is configured to present the graphical representation of the physical activity within an interactive virtual environment, the interactive virtual environment comprising an interface for replaying the user's participation in the physical activity based on the activity data.

13. The apparatus of claim 12, wherein the visualization module is configured to present graphical representations of activity data for a plurality of users simultaneously within the interactive virtual environment, the interactive virtual environment presenting comparison information associated with the activity data for the plurality of users.

14. The apparatus of claim 1, further comprising a recommendation module configured to generate one or more recommendations for the physical activity.

15. A method comprising:
tracking a user's participation in a physical activity;
collecting activity data in response to tracking the user's participation in the physical activity; and
matching one or more sponsors associated with the physical activity to the user based on information associated with the activity data, the one or more sponsors providing one or more retail incentives to the user.

16. The method of claim 15, further comprising validating the user's participation in the physical activity by verifying the activity data, the activity data being stored in a data repository associated with the physical activity.

17. The method of claim 15, wherein the one or more retail incentives provided by the one or more sponsors are based on one or more characteristics of the physical activity, the one or more characteristics determining a value of the one or more retail incentives.

18. The method of claim 15, wherein the information associated with the activity data comprises bids from a plurality of sponsors, bids from the one or more matched sponsors comprising winning bids.

19. The method of claim 15, further comprising generating a graphical representation of the physical activity based on the activity data, the graphical representation of the physical activity being presented within an interactive virtual environment, the interactive virtual environment comprising an interface for replaying the user's participation in the physical activity based on the activity data.

20. A computer program product comprising a computer readable storage medium storing computer usable program code executable to perform operations, the operations comprising:
tracking a user's participation in a physical activity;
collecting activity data in response to tracking the user's participation in the physical activity; and
presenting one or more retail incentives to the user based on the activity data, the one or more retail incentives being offered by one or more sponsors associated with the physical activity.
